(19) United States
(12) Patent Application Publication
(10) Pub. No.: US 2012/0254158 A1
(43) Pub. Date: Oct. 4, 2012

(54) AGGREGATING PRODUCT REVIEW INFORMATION FOR ELECTRONIC PRODUCT CATALOGS

(75) Inventor: Feng HE, Beijing (CN)

(73) Assignee: GOOGLE Inc., Mountain View, CA (US)

(21) Appl. No.: 13/230,277

(22) Filed: Sep. 12, 2011

(30) Foreign Application Priority Data
Mar. 29, 2011 (CN) PCT/CN2011/072248

(51) Int. Cl. G06F 17/30

(52) U.S. Cl. 707/722; 707/E17.014

(57) ABSTRACT

A product catalog includes information regarding products for sale online by various merchants, including product review information. An analysis module collects product reviews and determines whether each product review includes a product identifier, such as a Global Trade Item Number (“GTIN”). For product reviews having a product identifier, the module adds the product review to the product catalog and associates the product review with the product identifier. For product reviews lacking a product identifier, the module initiates an Internet search using information from the product review and analyzes search results to identify a product identifier for the product review. If the analysis module identifies a product identifier for the product review, the analysis module adds the product review to the product catalog and associates the product review with the identified product identifier. The analysis module may discard product reviews that are not associated with a product identifier.

### CROSS REFERENCE TO RELATED APPLICATION

This patent application is a continuation of and claims priority to PCT International Patent Application No. PCT/CN2011/072248, entitled, “Aggregating Product Review Information for Electronic Product Catalogs,” filed in China on Mar. 29, 2011, the complete disclosure of which is hereby fully incorporated herein by reference.

### TECHNICAL FIELD

The present disclosure relates generally to electronic product catalogs and, more specifically, to aggregating product review information for electronic product catalogs and associating the product review information with products in the product catalog.

### BACKGROUND

Computer networks, such as the Internet, enable transmission and reception of a vast array of information. In recent years, for example, some commercial retail stores have attempted to make product information available to customers over the Internet. It is becoming increasingly popular for information providers to provide mechanisms by which consumers can compare such product information across multiple manufacturers and retailers. For simplicity, manufacturers, retailers, and others that sell products to customers are interchangeably referred to herein as “merchants.” For example, Internet search/shopping sites allow customers to compare pricing information for products across multiple merchants.

In addition to pricing information, the information providers also provide product review information intended to help customers select a product for purchase. For example, some information providers allow users to submit their personal review of a product. However, even having the ability to accept user submitted review information, some products may still have little if any review information. Therefore, it is desirable to provide a mechanism to obtain review information for products from other sources. It is further desirable to provide a mechanism that associates received review information with products or product offers.

### SUMMARY

In certain exemplary embodiments, a computer-implemented method for aggregating product review information for an electronic product catalog includes a computer receiving information regarding a product review for a product. The computer determines whether the received information includes a product identifier identifying the product. In response to a determination that the received information does not include a product identifier, the computer initiates a search using at least a portion of the received information. The computer analyzes search results resulting from the search to identify a product identifier for the product review. In response to identifying a product identifier for the product review, the computer adds the information regarding the product review to the electronic product catalog. The added information is associated with the identified product identifier in the product catalog.

In certain exemplary embodiments, a computer-implemented method for aggregating product review information for an electronic product catalog includes a computer receiving information regarding a product. The computer determines whether the received information includes information uniquely identifying the product. In response to a determination that the received information does not include information uniquely identifying the product, the computer initiates a search using at least a portion of the received information. The computer analyzes search results resulting from the search to identify information uniquely identifying the product. In response to identifying information uniquely identifying the product, the computer adds the information regarding the product to the electronic product catalog. The added information is associated with the information uniquely identifying the product in the product catalog.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 depicts a system for aggregating product information for electronic product catalogs, in accordance with certain exemplary embodiments.

FIG. 2 is a block flow diagram depicting a method for aggregating product review information for electronic product catalogs, in accordance with certain exemplary embodiments.

FIG. 3 is a block flow diagram depicting a method for identifying a product identifier for a product review, in accordance with certain exemplary embodiments.

### DETAILED DESCRIPTION OF EXEMPLARY EMBODIMENTS

### Overview

The method and system described herein enable aggregation of product review information for electronic product catalogs. The system includes a product catalog system, which is implemented in hardware and/or software. The product catalog system receives information regarding products offered from multiple merchants. Generally, this information typically includes, for each product, a product title, a product description, pricing information, a product category, one or more images of the product, and a product identifier, such as a global trade item number (“GTIN”), universal product code (“UPC”), manufacturer's part number (“MPN”), international standard book number (“ISBN”), European article number (“EAN”), Japanese Article Number (“JAN”), and/or brand name and model number combination. As used throughout this specification, the term “products” should be interpreted to include tangible and intangible products, as well as services.

An analysis module of the product catalog system can analyze product reviews to determine whether the product reviews are associated with a product in the product catalog. When the product catalog receives product reviews or product review information, for example by “crawling” the Internet or via an electronic feed, the analysis module can determine whether each product review is associated with a product in the product catalog. For example, the analysis module may determine whether each product review includes a product identifier and, if so, compare the product identifier of the product review to product identifiers of products in the catalog. If the product review does not include a product identifier, the analysis module may extract information, such as the title of the product review, and perform an Internet search using at least the extracted information. The analysis module may then analyze results from the Internet search to identify a product identifier associated with the product review and compare the identified product identifier to the product identifiers of the products in the catalog. If the product identifier of the product review matches the product identifier of a product in the catalog, the analysis module may associate the product review with the matching product.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing system. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

Turning now to the drawings, in which like numerals indicate like elements throughout the figures, exemplary embodiments of the invention are described in detail.

### System Architecture

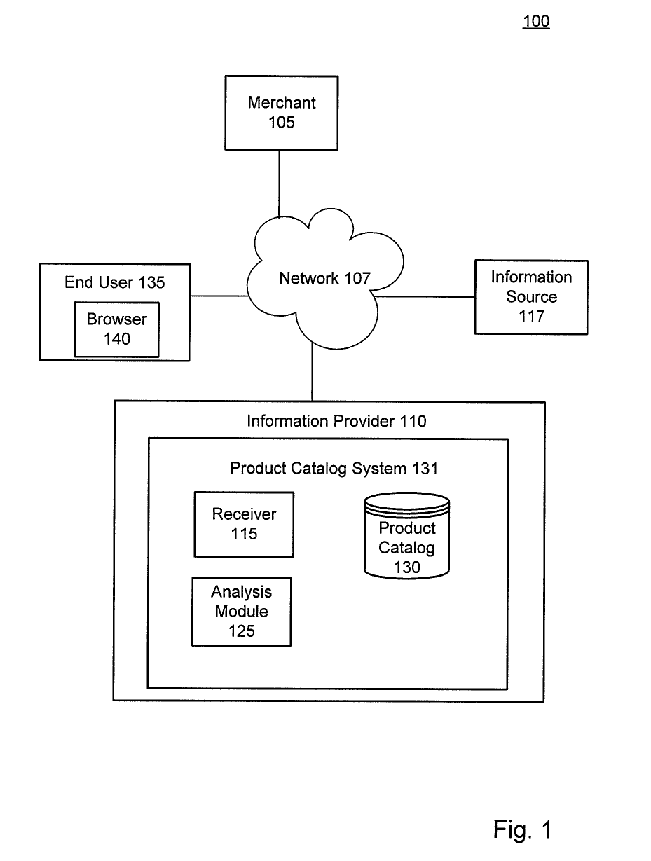

FIG. 1 depicts a system 100 for aggregating product information for electronic product catalogs, in accordance with certain exemplary embodiments. As depicted in FIG. 1, the system 100 includes network devices 105, 110, 117, and 135 that are configured to communicate with one another via one or more networks 107. Each network 107 includes a wired or wireless telecommunication means by which network devices (including devices 105, 110, 117, 135) can exchange data. For example, each network 107 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 105, 110, 117, 135 includes a device capable of transmitting and receiving data over the network 107, such as one or more computers. For example, each network device 105, 110, 117, 135 can include a server, desktop computer, laptop computer, smartphone, handheld computer, personal digital assistant (“PDA”), or any other wired or wireless, processor-driven device. In the exemplary embodiment depicted in FIG. 1, the network devices 105, 110, 117, 135 are operated by merchants, an information provider, an information source, and end user customers, respectively.

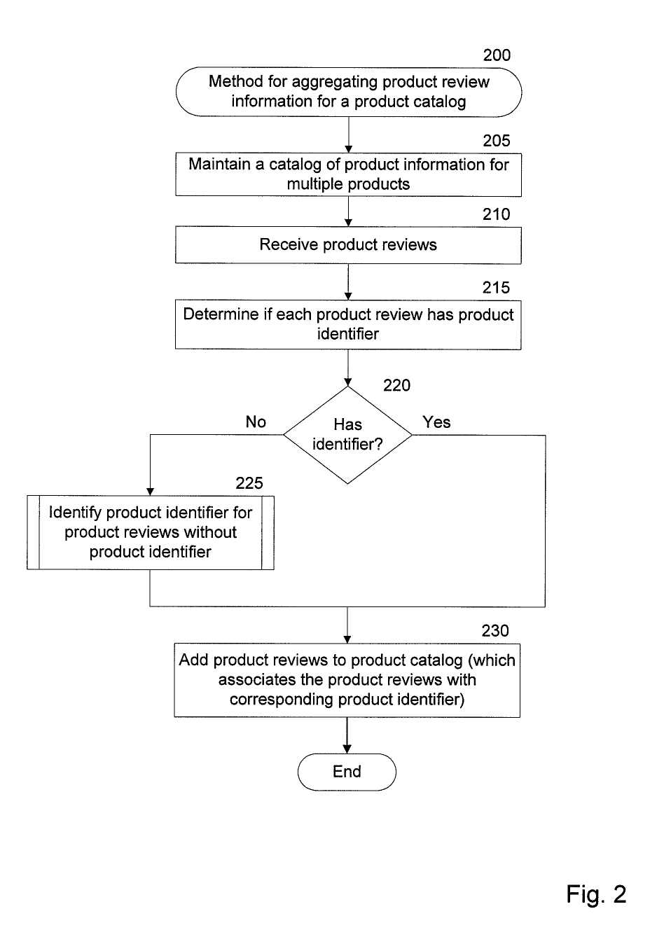

The end user network devices 135 each include a browser application module 140, such as Microsoft Internet Explorer, Firefox, Netscape, Google Chrome, or another suitable application for interacting with web page files maintained by the information provider network device 110 and/or other network devices. The web page files can include text, graphic, images, sound, video, and other multimedia or data files that can be transmitted via the network 107. For example, the web page files 107 can include one or more files in the HyperText Markup Language (“HTML”). The browser application module 140 can receive web page files from the information provider network device 110 and can display the web pages to an end user operating the end user network device 135. In certain exemplary embodiments, the web pages include information from a product catalog 130 of a product catalog system 131, which is maintained by the information provider network device 110. The product catalog system 131 is described in more detail hereinafter with reference to the method illustrated in FIG. 2.

### System Process

FIG. 2 is a block flow diagram depicting a method 200 for aggregating product review information for electronic product catalogs, in accordance with certain exemplary embodiments. The method 200 is described with reference to the components illustrated in FIG. 1.

In block 205, the product catalog system 131 maintains the product catalog 130. The product catalog 130 includes a data structure, such as one or more databases and/or electronic records, that includes information regarding products from at least one merchant, such as the merchant 105. For each product, the information typically includes at least a product identifier, such as a GTIN, UPC, MPN, ISBN, EAN, JAN, brand name and model number combination, and/or another standardized or non-standardized identifier. The product information also can include, for each product, a product title, a product description, pricing information, a product category, one or more images of the product, and any other information associated with the product.

Generally, the product identifiers uniquely identify their corresponding products. Information, other than the aforementioned product identifiers, that uniquely identifies a product also can be used as a product identifier. For example, a product identifier may be a string of alphanumeric characters and/or symbols that uniquely identify a product. In another example, a product identifier, may be a product title, a product description, a trademark or service mark for a product or service, or a Uniform Resource Locator (“URL”) or other type of link to a product or associated with a product. In certain exemplary embodiments, the product identifier may include a portion of one of the aforementioned product identifiers only. For example, some product identifiers, such as UPCs, include information identifying a manufacturer and a product. In certain exemplary embodiments, the product identifier stored in the product catalog includes the portion of the product identifier that identifies the product only or some other portion of the product identifier.

In certain exemplary embodiments, a receiver module 115 of the product catalog system 131 receives information that is included in the product catalog 130 in electronic data feeds and/or hard copy provided by one or more merchants, such as merchant 105, and/or another information source 117, such as a specialized information aggregator or an Internet web site. For example, each merchant 105 and/or information source 117 may periodically provide batched or unbatched product data in an electronic feed to the receiver module 115. The receiver module 115 also may receive product information from scanned product documentation and/or catalogs. In certain exemplary embodiments, the receiver module 115 also may receive the product data from a screen scraping mechanism, which is included in or associated with the product catalog system 131. For example, the screen scraping mechanism may capture product information from merchant and/or information provider websites. In certain exemplary embodiments, end users may view information from the product catalog 130 via browsers 140 on their respective end user network devices 135.

In block 210, the receiver module 115 or another module receives product review information for one or more products. That is, the receiver module 115 or another module receives one or more product reviews that are each associated with a product. Generally, the product reviews each include comments, ratings, recommendations, opinions, and/or a personal account or report for the product. The product reviews may include product reviews published by consumers and/or product reviews published by experts or columnists having detailed knowledge of the product and other products in the same field or technology.

In certain exemplary embodiments, the product catalog system 131 includes a web crawler that browses the Internet for product review information. For example, the receiver module 115 may receive the product review information from a screen scraping mechanism, which is included in or associated with the product catalog system 131. The screen scraping mechanism may capture product review information from merchant and/or information provider web sites. For example, many merchants and consumer web sites include product review information submitted by consumers or published by product experts that have interacted with the product. The screen scraping mechanism can seek out and capture this information.

In certain exemplary embodiments, the product catalog system 131 includes a product review retrieval mechanism that searches for product reviews associated with a particular product. For example, if certain products have a low number of reviews or no reviews at all, the product review retrieval mechanism may search for reviews related to those products. A screen scraping mechanism as described above can then capture any found product review information for the products.

In certain exemplary embodiments, the receiver module 115 receives the product review information via an electronic feed provided by one or more merchants, the information provider 117, such as a specialized product review aggregator, or another source. For example, an Internet web site directed to publishing product review information for a multitude of products may provide batched or unbatched product review information in an electronic feed to the receiver module 115. In another example, an Internet web site having forums or message boards for consumers to provide product review information may provide batched or unbatched product review information in an electronic feed to the receiver module 115.

In certain exemplary embodiments, the receiver module 115 also may receive product review information from a user via the end user network device 135. For example, the user may search for product information stored in the product catalog 130 and find a product that the user has interacted with. The user may then provide a review or rating for the product. The receiver module 115 also may receive product information from scanned product documentation and/or catalogs.

Regardless of how the product review information is received, in block 215, an analysis module 125 of the product catalog system 131 analyses or evaluates each received product review (or product review information) to determine whether the product review includes a product identifier for the product subject to the product review. For example, the analysis module 125 can analyze text of each product review to determine whether the text includes a product identifier, such as a GTIN, UPC, MPN, ISBN, EAN, JAN, brand name and model number combination, and/or another standardized or non-standardized identifier.

In certain exemplary embodiments, the analysis module 125 compares alphanumeric strings of each product review to formats of one or more types of product identifiers. If an alphanumeric sting matches a product identifier format type, the analysis module 125 may determine that the product review includes a product identifier. In certain exemplary embodiments, the analysis module 125 may compare each string of characters of the product review against a list of known product identifiers and if there is a match, the analysis module 125 may determine that the product review includes a product identifier. For example, the product catalog 130 may include a list of product identifiers for products in the product catalog or a list of known product identifiers regardless of whether the known product identifiers relate to products in the product catalog 130. In certain exemplary embodiments, the analysis module 125 compare strings of characters matching a product identifier format to the list of known product identifiers and if there is a match, determines that the product review includes a product identifier.

If the analysis module 125 determines that a product review includes a product identifier, the method 200 follows the “Yes” branch from block 220 to block 230 for that product review. If the analysis module 125 determines that a product review does not include a product identifier, the method 200 follows the “No” branch from block 220 to block 225 for that review.

In certain exemplary embodiments where a batch of product reviews is received by the receiver module 115, the analysis module 125 or another module may group product reviews having product identifiers into a first group while grouping product reviews that do not have a product identifier into a second group. These two groups of product reviews can be processed separately according to the following blocks.

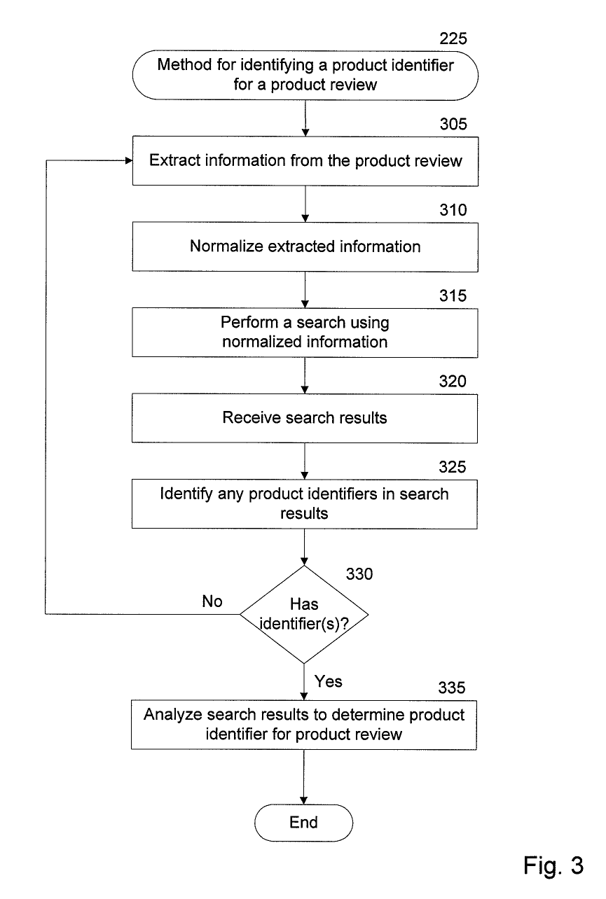

In block 225, the analysis module 125 identifies a product identifier for each product review that does not have a product identifier. In one exemplary embodiment, the analysis module 125 performs a search, such as an Internet search, using information of the product review and analyzes search results to identify the product identifier for the product review. Block 225 is described in more detail hereinafter, with reference to FIG. 3.

In block 230, the analysis module 125 adds information for each product review having a product identifier to the product catalog 130. For example, the analysis module 125 may add the entirety of each product review having a product identifier to the product catalog 130. The analysis module 125 also associates or otherwise links the added information to the product identifier, and thus to the product associated with the product identifier.

FIG. 3 is a block flow diagram depicting a method 225 for identifying a product identifier for a product review, in accordance with certain exemplary embodiments, as referenced in block 225 of FIG. 2. In block 305, the analysis module 125 extracts information from a product review that has been determined to not have a product identifier. As discussed below, the extracted information is used to find a product identifier for the product review, for example by way of an Internet search. In certain exemplary embodiments, the analysis module 125 extracts the title of the product review. In certain exemplary embodiments, the analysis module 125 analyzes the product review to identify a product title, such as “MOTOROLLA XOOM,” and extracts the identified product title from the product review. In certain exemplary embodiments, the analysis module 125 extracts at least a portion of the product description or an image of the product from the product review.

In certain exemplary embodiments, the analysis module 125 analyzes the extracted information to determine whether to use the extracted information in a search. If the analysis module 125 determines to not use the extracted information, the analysis module 125 may discard the product review. In certain exemplary embodiments, if the title for the product review is too short or does not adequately identify the product subject to the review, the analysis module 125 may discard the product review rather than attempt to find a product identifier for the review. For example, a product review having the title, “Don't buy this camera” may be discarded for lack of product identifying information in the product review title as the actual camera is not identified. In another example, if the title of the product review contains less than four words, the analysis module 125 may discard the product review rather than search for a product identifier for the product review.

In certain exemplary embodiments, the analysis module 125 identifies a category for the product of the product review and determines whether to discard the product review based on the category. For example, the information provider 110 may be interested in providing product reviews for products in certain categories only, such as for electronic devices. In another example, the information provider 110 may not be interested in providing product reviews for items that typically do not receive reviews. If the category for the product of the product review is not of interest to the information provider 110, the analysis module 125 may discard the product review rather than search for a product identifier for the product review.

In block 310, the analysis module 125 normalizes the extracted information. In certain exemplary embodiments, the analysis module 125 normalizes the extracted information by discarding any unnecessary words or words that are not likely to assist in finding search results having a product identifier. For example, the analysis module 125 may discard certain words or certain types of words unrelated to a product, such as the conjunctions “and” and “or” to name a couple of examples.

In certain exemplary embodiments, the analysis module 125 normalizes the extracted information by emphasizing brand or manufacturer names in the extracted information. The brand or manufacturer name of a product can be very useful in finding more information regarding a product, including product review information for a product. For example, the brand or manufacturer name may lead a search engine to the Internet web site of the brand or manufacturer, which often publishes product identifiers for products displayed at the web site.

In block 315, the analysis module 125 initiates an Internet search using the normalized information. For example, the analysis module 125 may initiate a search at an Internet search engine and provide the normalized information to the Internet search engine as a search query. In response, the Internet search engine provides at least one search result corresponding to the search query. The search results may be ordered or ranked according to the search results' relevance to the search query.

In certain exemplary embodiments, the analysis module 125 may initiate the search using the normalized information along with supplemental information, such as a type of product identifier. For example, the analysis module 125 may add certain terms, such as “UPC number,” to the search query to indicate to the search engine that the UPC number for the product review is desired. Thus, the analysis module 125 may initiate a search using “MOTOROLLA XOOM UPC number” as the query to find the UPC number for a MOTOROLLA XOOM product.

In block 320, the analysis module 125 receives the search results from the Internet search engine. In block 325, the analysis module 125 analyzes the search results to identify any product identifiers in the search results. For example, the analysis module 125 may compare alphanumeric strings of each search result to formats of one or more types of product identifiers. If an alphanumeric sting matches a product identifier format type, the analysis module 125 may determine that the search results include a product identifier. In certain exemplary embodiments, the analysis module 125 may compare each string of characters of each search result to a list of known product identifiers and if there is a match, the analysis module 125 may determine that the search result includes a product identifier. For example, as discussed above, the product catalog 130 may include a list of product identifiers for products in the product catalog or a list of known product identifiers regardless of whether the known product identifiers relate to products in the product catalog 130. In certain exemplary embodiments, the analysis module 125 compares strings of characters matching a product identifier format to the list of known product identifiers and if there is a match, determines that the search results include a product identifier.

In certain exemplary embodiments, rather than analyzing each and every search result, the analysis module 125 analyzes a portion of the search results only. For example, the analysis module 125 may analyze the higher ranked search results only while ignoring lower ranked search results. In one implementation, the analysis module 125 may analyze the top 50 ranked search results while ignoring any search results ranked lower than the top 50. In another example, the analysis module 125 may analyze a first portion in a first iteration and if the analysis module 125 does not identify a product identifier in the first portion, the analysis module 125 may analyze a second portion of the search results.

In block 330, if the analysis module 125 identifies one or more product identifiers in the search results, the method 225 follows the “Yes” branch to block 335. Otherwise, if the analysis module 125 does not identify any product identifiers in the search results, the method 225 follows the “No” branch to block 305 where the analysis module 125 extracts more or different information from the product review. For example, if a search using the title of the product review failed to result in an identified product identifier, then the analysis module 125 may extract a product title, model number, manufacturer or brand name, and/or product description for use in an updated search. Alternatively, the analysis module 125 may discard the product review in response to not identifying a product identifier rather than performing another search.

In block 335, the analysis module 125 analyzes the search results to identify the product identifier for the product review. The analysis module 125 can perform one of several processes to identify the product identifier for the product review and the process performed may be based on the number of product identifiers the analysis module 125 identifies in the search results.

In certain exemplary embodiments, if the analysis module 125 identifies a single product identifier in the search results only, the analysis module 125 may identify that one product identifier as the product identifier for the product review without any further analysis. In certain alternative embodiments, if the analysis module 125 identifies a single product identifier in the search results only, the analysis module 125 may further analyze the one product identifier. For example, the analysis module 125 may compare the one product identifier to a list of product identifiers for products in the product catalog or to a list of known product identifiers. If there is a match between the one product identifier and a product identifier in the list, the analysis module 125 may identify the one product identifier as the product identifier for the product review without further analysis. Or, the analysis module 125 may compare information regarding the product review with information regarding the product to confirm that the product review is associated with the product prior to identifying the product identifier as the product identifier for the review. For example, the product review may include a product or brand name and if the product or brand name of the product review matches the product or brand name of the product in the product catalog associated with the product identifier, the analysis module 125 may identify the product identifier as the product identifier for the product review.

If the analysis module 125 identifies multiple product identifiers in the search results, the analysis module 125 may analyze the search results to determine which of the multiple product identifiers, if any, correspond to the product review. In certain exemplary embodiments, the analysis module 125 considers the number of occurrences when determining which of the multiple product identifiers corresponds to the product review. For example, the analysis module 125 may count the number of occurrences of each product identifier in the search results and identify the product identifier having the greatest number of occurrences as the product identifier for the product review. In certain exemplary embodiments, the analysis module 125 considers the number of occurrences of each product identifier along with other information. For example, if there are two product identifiers having a similar number of occurrences, the analysis module 125 may further analyze information in the search results to determine which product identifier corresponds to the product review. The analysis module 125 may analyze information in the search results to determine which search results have product information that best matches any product information or product description included in the product review.

In certain exemplary embodiments, if the analysis module 125 identifies multiple product identifiers in the search results, the analysis module 125 considers the rank of the search results for each identified product identifier. For example, if the search results for a first product identifier are ranked higher for the search query than the search results for a second product identifier, the analysis module 125 may identify the first product identifier as the product identifier for the product review. The search result rankings can be used with other information, including the number of occurrences of each product identifier, to determine which of multiple product identifiers is associated with the product review.

In certain exemplary embodiments, if the analysis module 125 identifies multiple product identifiers in the search results, the analysis module 125 considers the distance between search words and the product identifier in the search results. For example, the analysis module 125 may identify the location of one or more of the terms of the search query in each search result and the location of the identified product identifier in each search result. The analysis module 125 may then determine the distance, for example in number of characters, between the term(s) and the product identifier. The analysis module 125 may calculate a metric based on each determined distance for each product identifier and determine, based on the metric, which of the product identifiers is associated with the product review. For example, the analysis module 125 may calculate, for each occurrence of a product identifier, an average distance between the product identifier and each term of the search query. The analysis module 125 may repeat this calculation for each search result that the product identifier occurs in and calculate a total value for the product identifier, for example by averaging all of the calculated distances for the product identifier. The analysis module 125 may identify the product identifier having the lowest average distance as the product identifier for the product review. Of course, the analysis module 125 may also consider other information, such as the number of occurrences and search result ranking for each product identifier in the analysis.

In certain exemplary embodiments, if the analysis module 125 identifies multiple product identifiers in the search results, the analysis module 125 assigns a confidence value to each identified product identifier based on the analysis. Typically, the analysis module 125 identifies the product identifier having the highest confidence value as the product identifier for the product review. However, if neither of the product identifiers have a confidence value that meets or exceeds a threshold value, the analysis module 125 may discard the product review rather than selecting one of the product identifiers for the product review as the results may be inconclusive.

### General

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. Various modifications of, and equivalent blocks corresponding to, the disclosed aspects of the exemplary embodimentps, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A computer-implemented method for aggregating product review information for an electronic product catalog, comprising:
receiving, at a computer, information regarding a product review for a product;
determining, by the computer, whether the received information comprises a product identifier identifying the product; and
in response to a determination that the received information does not comprise a product identifier,
initiating, by the computer, a search using at least a portion of the received information,
analyzing, by the computer, search results resulting from the search to identify a product identifier for the product review, and
in response to identifying a product identifier for the product review, adding, by the computer, the information regarding the product review to the electronic product catalog, the added information being associated with the identified product identifier in the product catalog.

2. The computer-implemented method of claim 1, wherein the portion of the received information comprises a title for the product review.

3. The computer-implemented method of claim 1, further comprising normalizing the portion of the received information to produce normalized information prior to initiating the search, the search using the normalized information.

4. The computer-implemented method of claim 1, wherein the identified product identifier comprises one of a global trade item number (“GTIN”), a universal product code (“UPC”), a manufacturer's part number (“MPN”), an international standard book number (“ISBN”), a European article number (“EAN”), and a Japanese Article Number (“JAN”).

5. The computer-implemented method of claim 1, further comprising adding the received information to the electronic product catalog in response to determining that the received information comprises a product identifier identifying the product, the added information being associated with the identified product identifier in the product catalog.

6. The computer-implemented method of claim 1, further comprising adding the identified product identifier to the electronic product catalog in response to identifying a product identifier for the product review.

7. The computer-implemented method of claim 1, wherein the information regarding the product review is received with information regarding a plurality of product reviews for a plurality of product offers.

8. The computer-implemented method of claim 1, further comprising discarding the information regarding the product review in response to not identifying a product identifier for the product review.

9. The computer-implemented method of claim 1, wherein analyzing the search results to identify the product identifier for the product review comprises:
identifying a plurality of potential product identifiers in the search results;
determining which of the potential product identifiers occurs most often in the search results; and
identifying the potential product identifier that occurs most often as the product identifier for the product review.

10. The computer-implemented method of claim 1, wherein analyzing the search results to identify the product identifier for the product review comprises:
determining whether the search results comprise more than one potential product identifier; and
in response to a determination that the search results comprise more than one potential product identifier, analyzing each of the more than one potential product identifiers to determine which of the more than one product identifier is the product identifier for the product review.

11. The computer-implemented method of claim 10, further comprising, in response to a determination that the search results comprise one potential product identifier, identifying the one product identifier as the product identifier for the product review.

12. The computer-implemented method of claim 1, wherein analyzing the search results to identify the product identifier for the product review comprises:
identifying a plurality of potential product identifiers in the search results; and
determining a rank associated with each of the potential product identifiers based on a rank of respective search results that correspond to each of the potential product identifiers; and
identifying a potential product identifier having a better rank as the product identifier for the product review.

13. The computer-implemented method of claim 1, further comprising:
identifying a brand name in a title of the product review; and
emphasizing the identified brand name in the search.

14. A computer program product, comprising:
a computer-readable medium having computer-readable program code embodied therein for aggregating product review information for an electronic product catalog, the computer-readable medium comprising:
computer-readable program code for receiving information regarding a product review for a product;
computer-readable program code for determining whether the received information comprises a product identifier identifying the product; and
computer-readable program code for, in response to a determination that the received information does not comprise a product identifier,
initiating a search using at least a portion of the received information,
identifying a plurality of potential product identifiers in the search results,
determining which one of the potential product identifiers corresponds with the product review, and
adding the information regarding the product review to the electronic product catalog, the added information being associated with the identified product identifier in the product catalog based on the one the one of the potential product identifiers that corresponds with the product review.

15. The computer program product of claim 14, wherein the identified product identifier comprises one of a global trade item number (“GTIN”), a universal product code (“UPC”), a manufacturer's part number (“MPN”), an international standard book number (“ISBN”), a European article number (“EAN”), and a Japanese Article Number (“JAN”).

16. The computer program product of claim 14, wherein the portion of the received information comprises a title for the product review.

17. The computer program product of claim 14, further comprising computer-readable program code for normalizing the portion of the received information to produce normalized information prior to initiating the search, the search using the normalized information.

18. The computer program product of claim 14, further comprising computer-readable program code for adding the received information to the electronic product catalog in response to determining that the received information comprises a product identifier identifying the product, the added information being associated with the identified product identifier in the product catalog.

19. The computer program product of claim 14, further comprising computer-readable program code for adding the identified product identifier to the electronic product catalog in response to identifying a product identifier for the product review.

20. The computer program product of claim 14, wherein the information regarding the product review is received with information regarding a plurality of product reviews for a plurality of product offers, the received information being obtained using a web crawling mechanism.

21. The computer program product of claim 14, further comprising computer-readable program code for discarding the information regarding the product review in response to not identifying a product identifier for the product review.

22. The computer program product of claim 14, further comprising:
computer-readable program code for identifying a brand name in a title of the product review; and
computer-readable program code for emphasizing the identified brand name in the search.

23. A computer system for aggregating product review information for an electronic product catalog, comprising:
a processor, computer-readable memory, and a computer-readable storage device;
program instructions for receiving information regarding a product review for a product;
program instructions for determining whether the received information comprises a product identifier identifying the product;
program instructions for, in response to a determination that the received information does not comprise a product identifier,
initiating a search using at least a portion of the received information;
analyzing search results resulting from the search to identify a product identifier for the product review; and
in response to identifying a product identifier for the product review, adding the information regarding the product review to the electronic product catalog, the added information being associated with the identified product identifier in the product catalog,
wherein the program instructions are stored on the computer-readable storage device for execution by the processor via the computer-readable memory.

24. The computer system of claim 23, wherein the program instructions for analyzing the search results to identify the product identifier for the product review comprise:
program instructions for identifying a plurality of potential product identifiers in the search results;
program instructions for determining which of the potential product identifiers occurs most often in the search results; and
program instructions for identifying the potential product identifier that occurs most often as the product identifier for the product review.

25. The computer system of claim 23, wherein the program instructions for analyzing the search results to identify the product identifier for the product review comprise:
program instructions for determining whether the search results comprise more than one potential product identifier; and
program instructions for analyzing each potential product identifier to determine which of the more than one product identifier is the product identifier for the product review in response to a determination that the search results comprise more than one potential product identifier.

26. The computer system of claim 23, wherein the program instructions for analyzing the search results to identify the product identifier for the product review comprise:
program instructions for identifying a plurality of potential product identifiers in the search results; and
program instructions for determining a rank associated with each of the potential product identifiers based on a rank of respective search results that correspond to each of the potential product identifiers; and
program instructions for identifying a potential product identifier having a better rank as the product identifier for the product review.

27. A computer-implemented method for aggregating product review information for an electronic product catalog, comprising:
receiving, at a computer, information regarding a product;
determining, by the computer, whether the received information comprises information uniquely identifying the product; and
in response to a determination that the received information does not comprise information uniquely identifying the product,
initiating, by the computer, a search using at least a portion of the received information;
analyzing, by the computer, search results resulting from the search to identify information uniquely identifying the product; and
in response to identifying information uniquely identifying the product, adding, by the computer, the information regarding the product to the electronic product catalog, the added information being associated with the information uniquely identifying the product in the product catalog.

28. The computer-implemented method of claim 27, wherein the information regarding the product comprises product review information associated with the product.

29. The computer-implemented method of claim 27, wherein the information uniquely identifying the product comprises a product identifier.

30. The computer-implemented method of claim 29, wherein the product identifier comprises one of a global trade item number (“GTIN”), a universal product code (“UPC”), a manufacturer's part number (“MPN”), an international standard book number (“ISBN”), a European article number (“EAN”), and a Japanese Article Number (“JAN”).
